(19) United States
(12) Patent Application Publication
(10) Pub. No.: US 2003/0156191 A1
(43) Pub. Date: Aug. 21, 2003

(54) HEAD MOUNTED DISPLAY APPARATUS

(76) Inventor: SHINYA URISAKA, KAWASAKI-SHI (JP)

Correspondence Address: FITZPATRICK CELLA HARPER & SCINTO, 30 ROCKEFELLER PLAZA, NEW YORK, NY, 10112, US

(21) Appl. No.: 09/221,843

(22) Filed: Dec. 29, 1998

(30) Foreign Application Priority Data
Dec. 29, 1997 (JP) 9-369402
Dec. 21, 1998 (JP) 10-376151

(51) Int. Cl. H04N 7/00

(52) U.S. Cl. 348/121; 375/240.25; 348/51

(57) ABSTRACT

A head mounted display apparatus includes a main body portion and a decoder processing unit. The main body portion is be mounted on the head of an observer. The main body portion includes a video display unit, a video display drive circuit for displaying video on the video display unit, and an optical system for guiding the video displayed on the video display unit to the pupil of the observer, and the main body portion obtaining power from a power supply unit through a cable. The decoder processing unit converts an external input video signal into an RGB signal. The signal from the decoder processing unit is transmitted to the video display drive circuit. The decoder processing unit is disposed in a relay unit between the power supply unit and the main body portion.

### BACKGROUND OF THE INVENTION

1. Field of the Invention

The present invention relates a head mounted display apparatus which a user wears on, for example, his or her head or face to see a display.

2. Related Background Art

FIG. 1 is a block diagram showing the arrangement of a conventional head mounted display apparatus using compact, lightweight liquid crystal panels. The output of a decoder processing unit 1 to which a video signal is input and an output of a power supply circuit 3 connected to a power switch 2 are connected to a display drive circuit 4. The outputs of the power supply circuit 3 are respectively connected to backlights 6L and 6R for illumination through drivers 5L and 5R. The outputs of the display drive circuit 4 are respectively connected to left-/right-eye display elements 7L and 7R which are non-spontaneous liquid crystal that do not spontaneously emit light. Optical elements 8L and 8R which are prisms are respectively mounted on the left-/right-eye display elements 7L and 7R. Incident surfaces 8La and 8Ra, reflecting surfaces 8Lb and 8Rb, and half mirrors 8Lc and 8Rc are respectively formed on the optical elements 8L and 8R. Left-/right-eye display optical systems 9L and 9R are comprised of the left and right drivers 5L and 5R, the backlights 6L and 6R, the left-/right-eye display elements 7L and 7R, and the optical elements 8L and 8R.

When the power switch 2 is turned on, the power supply circuit 3 starts supplying necessary power to the overall head mounted display apparatus. An NTSC video signal from a TV tuner or video reproducing apparatus is sent to the decoder processing unit 1. A video signal from the decoder processing unit 1 is converted first into an RGB signal, which is sent to the display drive circuit 4. The display drive circuit 4 displays the video on the left-eye display element 7L and the right-eye display element 7R. At this time, since the left-/right-eye display elements 7L and 7R are not spontaneous display elements, they are respectively illuminated by the backlights 6L and 6R for illumination.

The left-/right-eye display optical systems 9L and 9R have the same arrangement. For example, the light beam emitted from the backlight 6L and transmitted through the display element 7L is incident on the incident surface 8La of the optical element 8L. This light beam is incident on the reflecting surface 8Lb at an incident angle larger than the critical angle to be totally reflected. The totally reflected light beam is reflected by the half mirror 8Lc. The light beam strikes again the reflecting surface 8Lb at an angle smaller than the critical angle to form an image on a pupil eL of the observer. As a result, the observer sees the enlarged video displayed on the display element 7L.

According to the prior art described above, however, since the decoder processing unit 1 and the display drive circuit 4 are incorporated in the drive mount portion of the head mounted display apparatus, the circuit size is large, and it is difficult to attain reductions in size and weight. In addition, if a character generator and a microcomputer, which are used to display characters while superimposing them on video, are arranged behind the decoder processing unit 1, the circuit size further increases.

### SUMMARY OF THE INVENTION

It is an object of the present invention to provide a head mounted display apparatus which can solve the above problem and attain reductions in size and wight by reducing the circuit size.

The above and other objects, features, and advantages of the present invention will be apparent from the following detailed description in conjunction with the accompanying drawings and the appended claims.

### BRIEF DESCRIPTION OF THE DRAWINGS

FIG. 1 is a block diagram showing the arrangement of a conventional head mounted display apparatus;

FIG. 2A is a perspective view showing a head mounted display apparatus according to the first embodiment of the present invention;

FIG. 2B is a block diagram showing the arrangement of the apparatus;

FIG. 3 is a block diagram showing the arrangement of a relay box in the second embodiment of the present invention;

FIG. 4 is a block diagram showing the arrangement of a relay box in the third embodiment;

FIG. 5 is a perspective view showing a control operation unit;

FIG. 6 is a view for explaining a window for electronic adjustment;

FIG. 7 is a schematic block diagram showing the arrangement of the fourth embodiment of the present invention;

FIG. 8 is a schematic perspective view showing the structure of a head mounted display apparatus according to the fourth embodiment;

FIG. 9 is a schematic block diagram showing the arrangement of a relay box according to the fifth embodiment of the present invention; and

FIG. 10 is a schematic block diagram showing the arrangement of the sixth embodiment of the present invention.

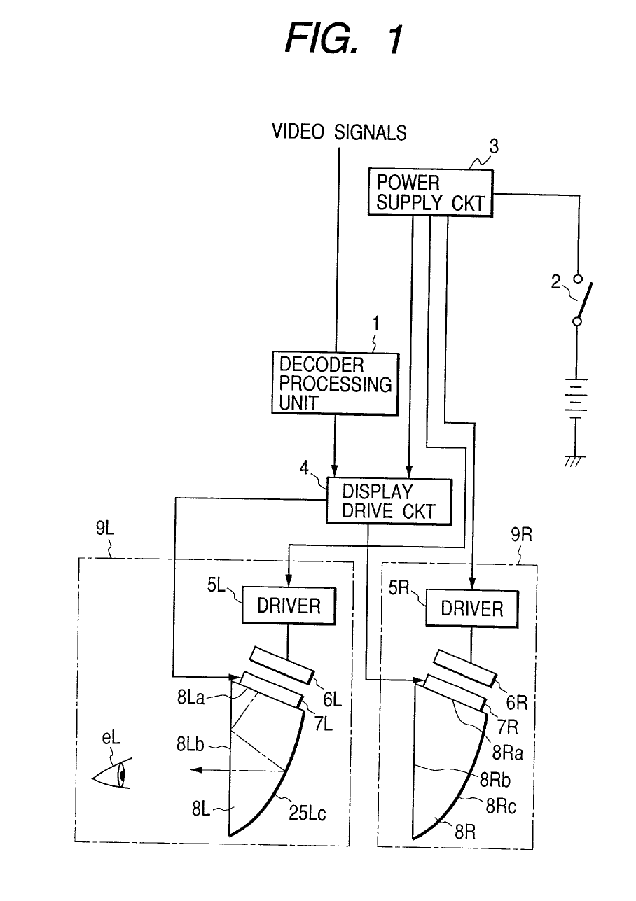

### DETAILED DESCRIPTION OF THE PREFERRED EMBODIMENTS

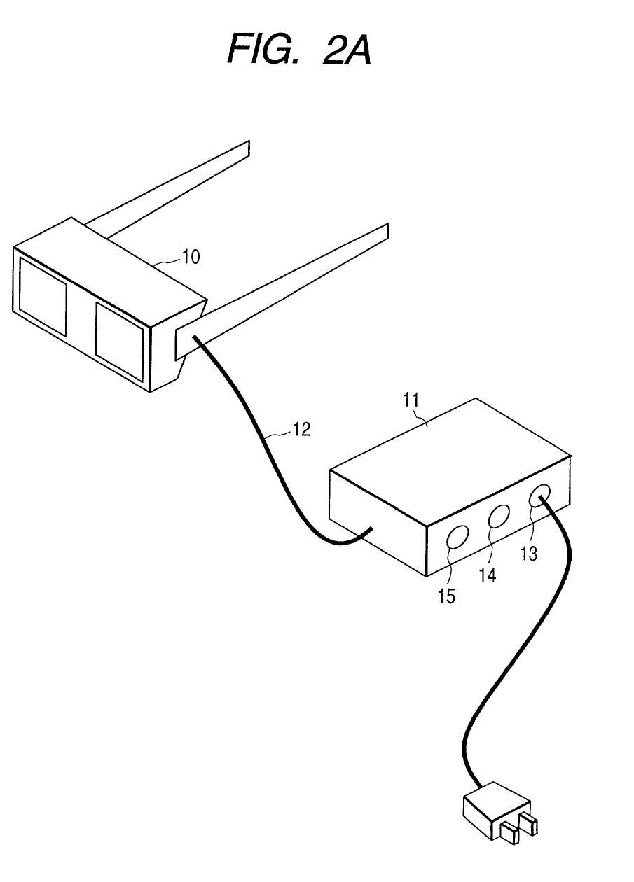

The embodiments of the present invention shown in FIGS. 2A to 6 will be described in detail below.

FIG. 2A is a perspective view showing a head mounted display apparatus according to the first embodiment. This head mounted display apparatus is comprised of a main body 10 of a video display and a relay box 11. The main body 10 is connected to the relay box 11 through a cable 12. The relay box 11 has a power supply jack 13, a video input jack 14 for receiving an NTSC video signal from a TV tuner or video reproducing apparatus, and an audio input jack 15. Note that the video input jack 14 and the audio input jack 15 can be integrated into one jack.

FIG. 2B is a block diagram showing the arrangement of the apparatus. In the relay box 11, the output of a power switch 16 is connected to a power supply circuit 17, the output of a signal processing unit 18 for receiving a video signal is connected to a decoder processing unit 19, and the output of a control unit 20 is connected to the signal processing unit 18 through a character generator 21. The main body 10 is comprised of a display drive circuit 22 and left-/right-eye display optical systems 23L and 23R. The outputs of the power supply circuit 17 and decoder processing unit 19 are connected to the display drive circuit 22.

The display optical systems 23L and 23R are respectively made up of display elements 24L and 24R which are non-spontaneous liquid crystal panels, prism-like optical elements 25L and 25R mounted on the display elements 24L and 24R, backlights 26L and 26R for illuminating the display elements 24L and 24R, and drivers 27L and 27R for driving the backlights 26L and 26R. The output of the power supply circuit 17 is connected to the backlights 26L and 26R. The outputs of the display drive circuit 22 are respectively connected to the display elements 24L and 24R. Note that the backlights 26L and 26R may be separately arranged for the left and right eyes, or one backlight common to the left and right eyes may be used to guide light through a light guide plate.

When the power switch 16 is turned on, the power supply circuit 17 starts supplying necessary power to the overall head mounted display apparatus. A television signal (NTSC video signal in this case) from a TV tuner or video reproducing apparatus is input to the relay box 11 and sent to the signal processing unit 18. The character generator 21 sends image data for a window to give the observer a caution/warning or to adjust brightness, color, and the like to the signal processing unit 18 in accordance with the instruction sent from the control unit 20.

The signal processing unit 18 mixes the input video signal and the image data from the character generator 21 and sends the resultant signal to the decoder processing unit 19. The decoder processing unit 19 converts the NTSC signal into an RGB signal. This RGB signal and power are output from the relay box 11 and sent to the display drive circuit 22 in the main body 10, which is to be mounted on the head of the user, through the cable 12. The display drive circuit 22 displays the video on the left-/right-eye display elements 24L and 24R, which are illuminated by the backlights 26L and 26R for illumination.

The left-/right-eye display elements 24L and 24R have the same arrangement. For example, the light beam emitted from the backlight 22L passes through the display element 20L and strikes an incident surface 21La of the optical element 21L. The light beam further strikes a reflecting surface 21Lb at an incident angle equal to or larger than the critical angle to be totally reflected. The totally reflected light beam is reflected by a half mirror 21Lc to strike the reflecting surface 21Lb again at an angle smaller than the critical angle. This light beam then forms an image on a pupil eL of the observer. As a result, the observer observes an enlarged video displayed on the display element 20L.

As described above, since the decoder processing unit 19 is disposed in the relay box 11 instead of the main body 10, the circuit size of the main body 10 to be mounted on the head of the user can be reduced, thus attaining reductions in the size and weight of the apparatus. In addition, with this reduction in circuit size, the current sent to the main body 10 can be reduced to attain a reduction in the capacitance of the cable 12 for connecting the relay box 11 to the main body 10. In addition, the relay box 11 may include an amplifier to amplify the amplitude of an RGB signal by using the amplifier and send the signal to the main body 10, thereby reducing the influences of noise on the RGB signal.

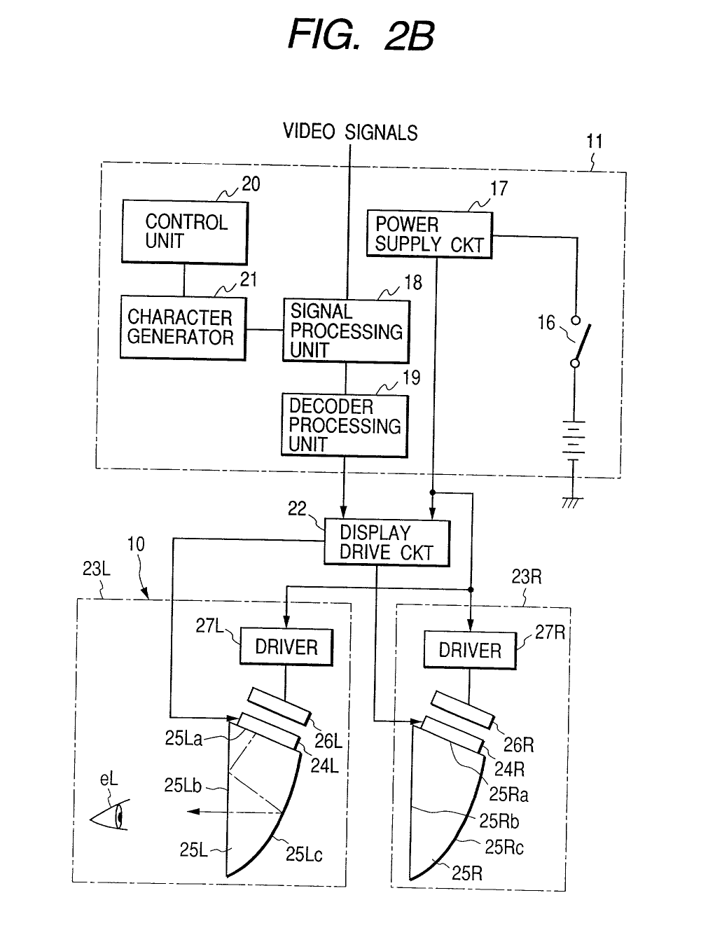

FIG. 3 is a circuit diagram showing the arrangement of a relay box 11 according to the second embodiment. In this embodiment, in the relay box 11, a video signal is input first to the decoder processing unit 19, and the output of the decoder processing unit 19 is connected to a signal processing unit 18. The principle of the technique of displaying an RGB signal on left-/right-eye display elements 24L and 24R and providing the observer with an enlarged video through the left-/right-eye display optical systems 23L and 23R is the same as that in the first embodiment.

When a power switch 16 is turned on, a power supply circuit 17 starts supplying necessary power to the overall head mounted display apparatus. An NTSC video signal from a TV tuner or video reproducing apparatus is input to the relay box 11 and sent to the decoder processing unit 19. The decoder processing unit 19 converts the NTSC signal into an RGB signal and sends it to the signal processing unit 18. A character generator 21 sends image data for a window to give the observer a caution/warning or to adjust brightness, color, and the like to the signal processing unit 18 in accordance with the instruction sent from a control unit 20. The signal processing unit 18 mixes the input video signal and the image data from the character generator 21. This RGB signal is output from the relay box 11 and sent to a display drive circuit 22 in a main body 10 of a video display through a cable 12 or the like.

As described above, according to the circuit configuration of the head mounted display apparatus, the character generator 21 for displaying a warning window for the observer or an adjustment window for brightness, color, and the like is disposed behind the decoder processing unit 19, and an RGB output from the character generator 21 is used. Therefore, the limitations imposed on color are fewer than those in a case wherein an NTSC output is used. This can realize display of a warning window and adjustment window that are easy to see for the observer. In addition, the general-purpose character generator 21 can be selected from a wider range of choices, leading to a reduction in cost.

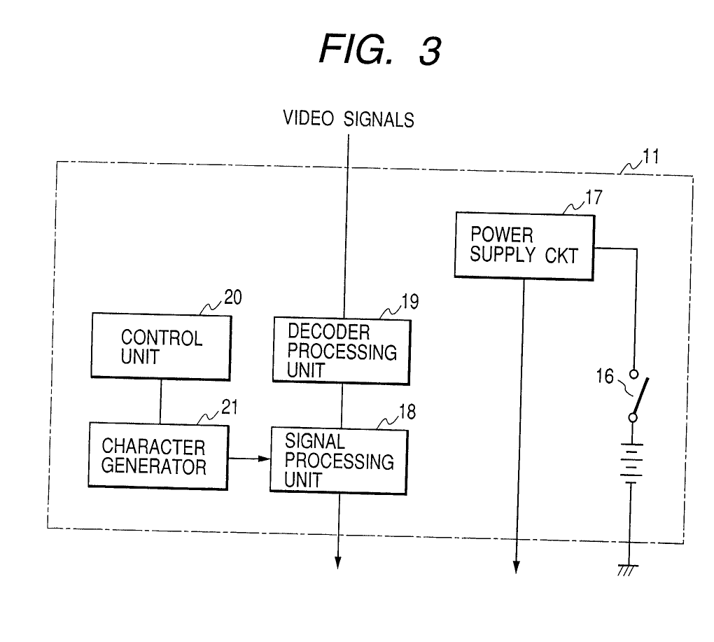

FIG. 4 is a block diagram showing the arrangement of a relay box 11 in the third embodiment. This relay box includes an adjustment value input means 28 in addition to the arrangement of the second embodiment. The output of the adjustment value input means 28 is connected to a decoder processing unit 19 through a control unit 20 and a D/A conversion circuit 29. The arrangement of the third embodiment is the same as that of the second embodiment except for the above arrangement.

When a power switch 16 is turned on, a power supply circuit 17 starts supplying necessary power to the overall head mounted display apparatus. An NTSC video signal from a TV tuner or video reproducing apparatus is input to the relay box 11 and sent to the decoder processing unit 19. The control unit 20 transmits brightness or color information to the decoder processing unit 19 in accordance with the adjustment value set by the observer using the adjustment value input means 28. In this case, the brightness or color information is D/A-converted by the D/A conversion circuit 29, and the resultant information is sent to the decoder processing unit 19. With this arrangement, the control unit 20 and the decoder processing unit 19 can be mounted on the same board, and electronic adjustment can be easily performed by using the control unit 20.

The decoder processing unit 19 converts the NTSC signal into an RGB signal in accordance with the brightness or color information received from the control unit 20. A character generator 21 sends image data for a window to give the observer a caution/warning or to adjust brightness, color, and the like to the signal processing unit 18 in accordance with the instruction sent from the control unit 20. The signal processing unit 18 mixes the input video signal and the image data from the character generator 21. This RGB signal is output from the relay box 11 and sent to a display drive circuit 22 in a main body 10 of a video display through a cable 12 or the like.

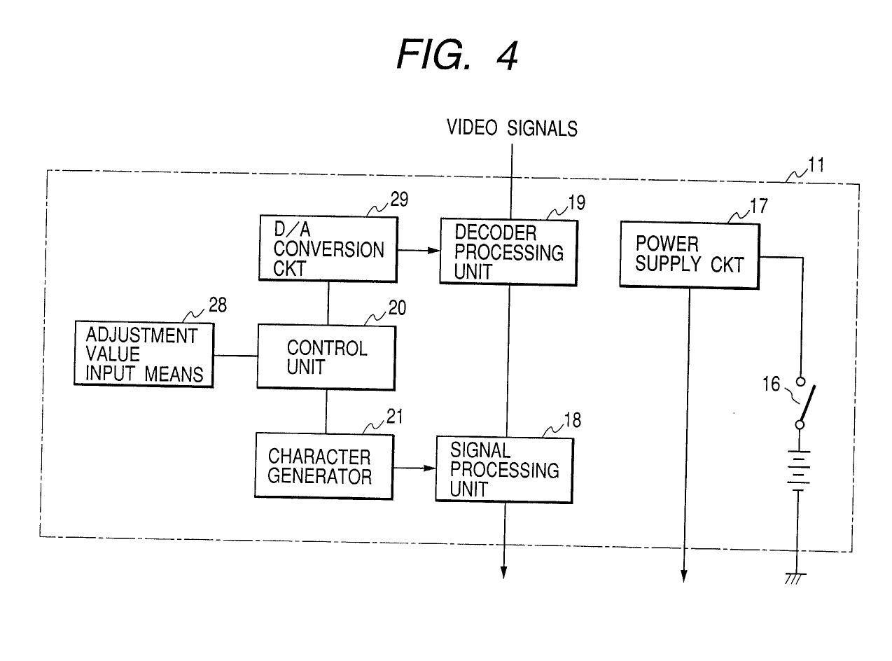

The adjustment value input means 28 allows the observer to perform setting with a button, a switch, or the like. For example, with a button disposed on the relay box 11 or a selection button 31 disposed on a control operation unit 30 capable of communicating with the relay box 11 as shown in FIG. 5, the observer can select and set brightness, tint, volume, and the like.

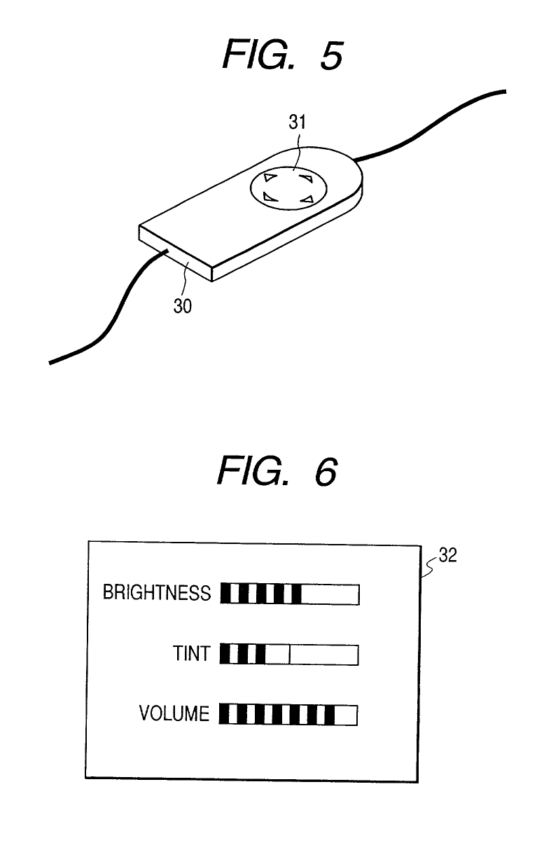

When the observer depresses the selection button 31, the control unit 20 sends an adjustment window display instruction to the character generator 21. Upon reception of the instruction, the character generator 21 sends an image signal for adjustment window display to the signal processing unit 18. As a result, an adjustment window 32 is displayed on the display screen, as shown in FIG. 6. The observer can set brightness, tint, volume, or the like by operating the selection button 31 while seeing the adjustment window 32.

As described above, since the decoder processing unit 19 and the microcomputer are mounted on the same board, electronic adjustment of brightness, tint, and volume can be easily performed under the control of the microcomputer. This can simplify the adjustment mechanism and reduce the number of parts such as resistors.

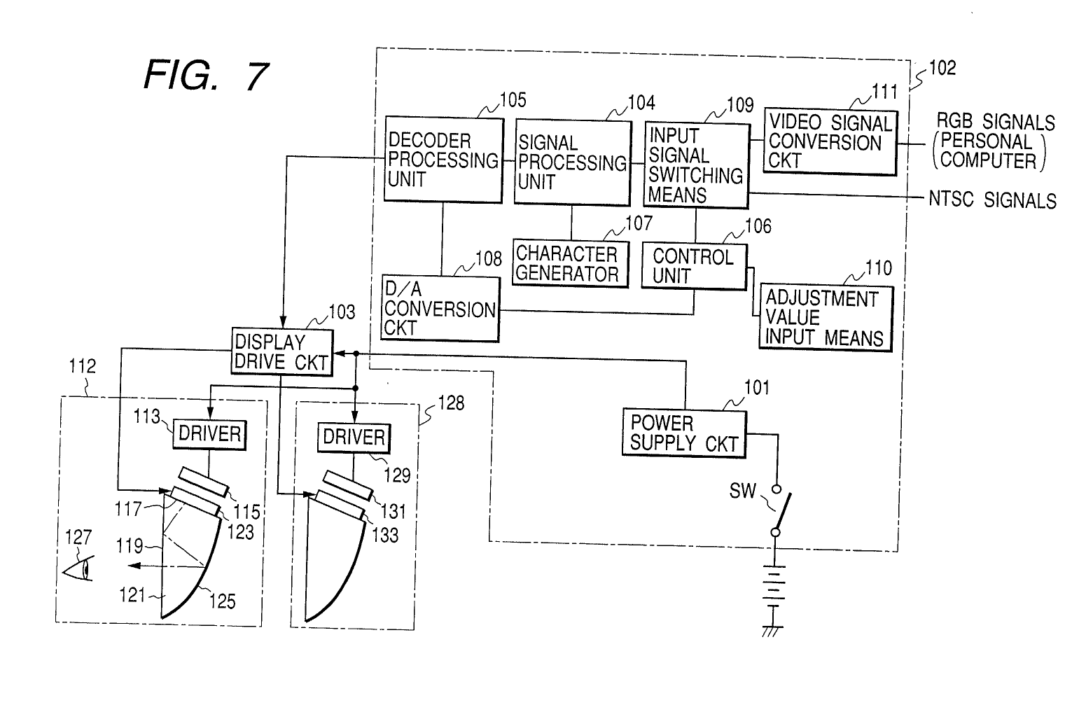

FIG. 7 is a block diagram showing the arrangement of the fourth embodiment of the present invention.

Referring to FIG. 7, when a power switch SW is turned on, a power supply 101 starts supplying necessary power to the overall head mounted display apparatus. In this embodiment, a television signal (NTSC signal) from a TV tuner or video reproducing apparatus as an input signal source or an analog RGB signal from a personal computer, compact information terminal, or the like as an input signal source is input to a relay box 102. The NTSC signal is sent to an input signal switching means 109. The analog RGB signal is converted into an NTSC signal by a video signal conversion circuit 111. This signal is then sent to the input signal switching means 109. A connector used for the input signal source and disposed in the relay box 102 has a sensor for identifying an input signal as an NTSC or RGB signal. A control unit 106 switches the input signal switching means 109 to the NTSC signal side or the RGB signal side in accordance with the signal sent from the sensor. The input signal selected by the input signal switching means 109 is sent to a signal processing unit 104. A character generator 107 sends image data for a window to give the observer a caution/warning or to adjust brightness, color, and the like to the signal processing unit 104 in accordance with the instruction sent from the control unit 106. The signal processing unit 104 mixes the input video signal and the image data from the character generator 107, and sends the resultant signal (NTSC signal) to a decoder processing unit 105. The control unit 106 sends brightness or color information to the decorder processing unit 105 in accordance with the adjustment value set by the observer using an adjustment value input means 110. In this case, the brightness or color information is D/A-converted by a D/A conversion circuit 108 and sent to the decoder processing unit 105. In this case, the control unit 106 and the decoder processing unit 105 can be mounted on the same board, and hence electronic adjustment by the control unit 106 is facilitated. The decoder processing unit 105 converts the NTSC signal into an RGB signal in accordance with the brightness or color information received from the D/A conversion circuit 108. This RGB signal is output from the relay box 102 and sent to a display drive circuit 103, disposed in the main mount portion, through a cable or the like. The display drive circuit 103 displays the video on left-/right-eye display element 123 and 133. In this case, since the left and right display elements 123 and 133 are not spontaneous display elements, backlights 115 and 131 for illumination are required. These backlights may be separately arranged as left-/right-eye backlights as shown in FIG. 7, or one backlight common to the left and right eyes may be disposed. This embodiment also includes left-/right-eye display systems 112 and 128. Since the left and right display systems are identical to each other, only the left-eye display system will be describe bellow. The light emitted from the backlight 115, guided by a light guide plate, and transmitted through the liquid crystal panel 123 strikes an incident surface 117 of an optical element 121. This light beam is then incident on a reflecting surface 119 at an incident angle equal to or more than the critical angle to be totally reflected. The totally reflected light is reflected by a half mirror 125. The light beam is incident on the reflecting surface 119 at an angle smaller than the critical angle to be formed into an image on a pupil 127 of the observer. As a result, the observer sees an enlarged video displayed on the display element 123.

Referring to FIG. 7, the RGB signal from the decoder processing unit is directly sent to the main body of the video display through the cable. However, to take measures against noise, the amplitude of the RGB signal may be amplified first by an amplifier, and then the amplified signal may be sent to the main body of the video display.

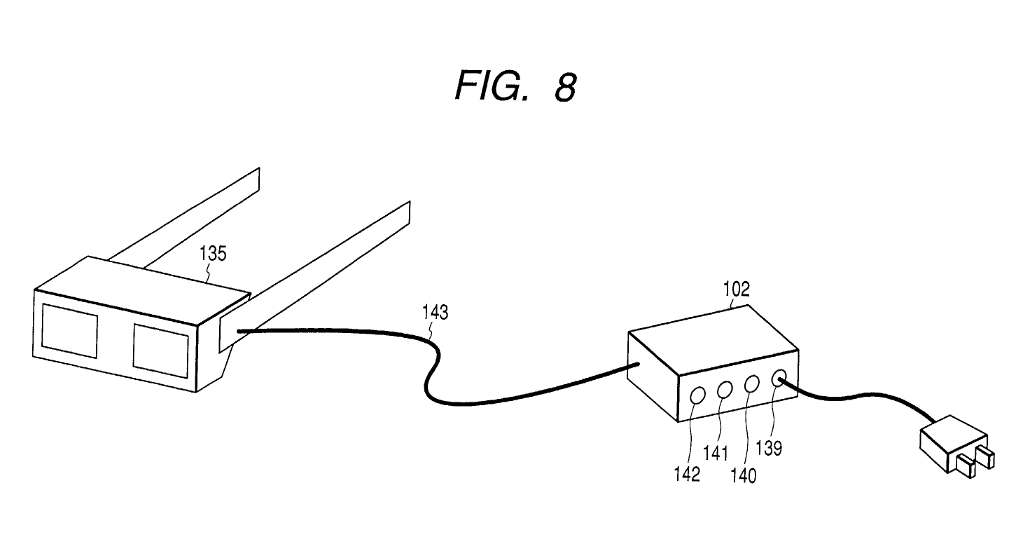

FIG. 8 schematically shows the structure of the head mounted display apparatus of this embodiment.

Referring to FIG. 8, the relay box 102 incorporates the power supply 101, the signal processing unit 104, the decoder processing unit 105, the control unit 106, the character generator 107, the D/A conversion circuit 108, the input signal switching means 109, the adjustment value input means 110, and the video signal conversion circuit 111. This apparatus includes a power supply jack 139 and video input jacks 140 and 141. The jack 140 receives a television signal (NTSC signal) from a TV tuner or video reproducing apparatus. The jack 141 receives an analog RGB signal from a personal computer, compact information terminal, or the like. The apparatus also includes an audio input jack 142. The video input jacks 140 and 141 and the audio input jack 142 may be integrated into one jack. A cable 143 is used to send the RGB signal converted by the decoder processing unit 105, power, and the like to a main body 135 of a video display.

Adjustment value input operation will be described in detail below.

The adjustment value input means 110 allows the observer to perform setting with a button, a switch, or the like. For example, with a button disposed on the relay box 102 or a selection button 31 disposed on a control operation unit 30 capable of communicating with the relay box 102 as shown in FIG. 5, the observer can set brightness, tint, volume, and the like in accordance with his/her preference. When the observer depresses the selection button 31, the control unit 106 sends an adjustment window display instruction to the character generator 107. Upon reception of the instruction, the character generator 107 sends an image signal for adjustment window display to the signal processing unit 104. As a result, an adjustment window like the one shown in FIG. 6 is displayed on the display screen. The observer can set a value such as brightness, tint, or volume by operating the selection button 31 while seeing the adjustment window.

As described above, since the decoder processing unit is disposed in the relay box instead of the main mount portion, the circuit size of the main body can be reduced, thereby attaining reductions in the size and weight of the apparatus. In addition, with this reduction in circuit size on the main body side, the current sent to the main body can be reduced, and a thin power line for connecting the relay box to the main body can be used. Since the decoder processing unit and the microcomputer are mounted on the same board, electronic adjustment of brightness, tint, and volume can be easily performed under the control of the microcomputer. This can simplify the adjustment mechanism and attain a reduction in the number of parts such as a volume. In addition, the relay box may include an amplifier to reduce the influences of noise on an RGB signal. Furthermore, this apparatus can display not only a television signal (NTSC signal) from a TV tuner, video reproducing apparatus, or the like but also an analog RGB signal from a personal computer, compact information terminal, or the like.

In the fifth embodiment described below, the arrangement of the relay box 102 in the fourth embodiment is replaced with the following arrangement. The principle of the technique of displaying an RGB signal from the relay box on the left-/right-eye display elements 123 and 133 and providing the observer with an enlarged video through the left-/right-eye display optical systems 112 and 128 is the same as that in the fourth embodiment.

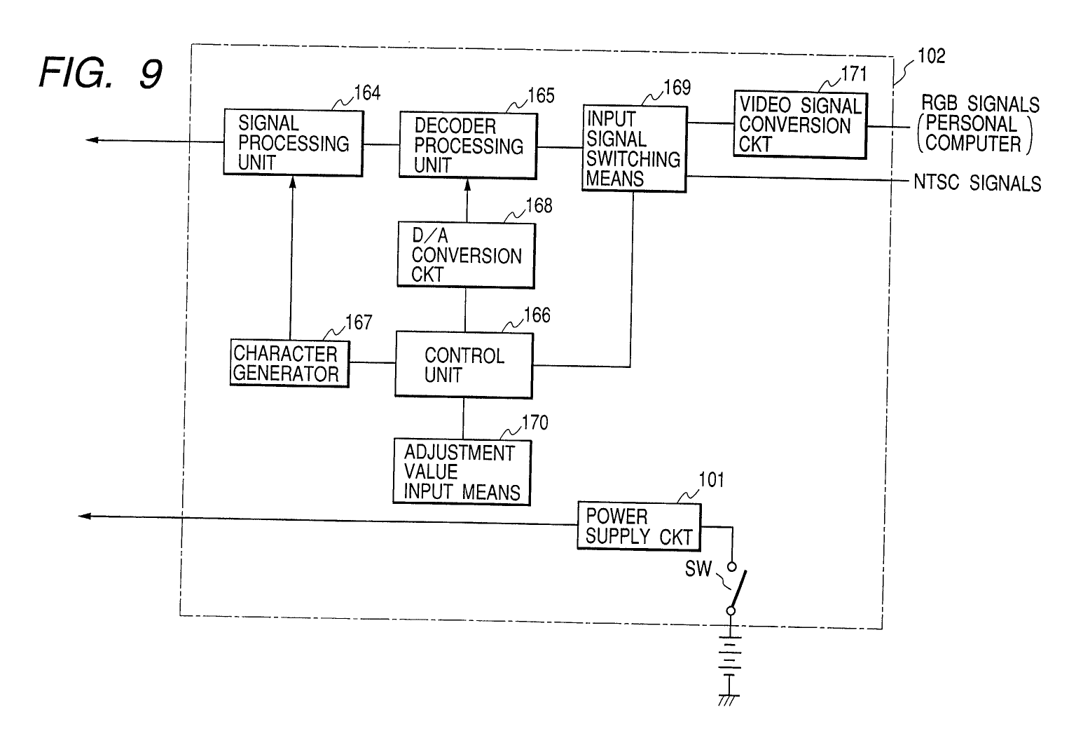

FIG. 9 schematically shows the arrangement of a relay box 102 in the fifth embodiment.

Referring to FIG. 9, when a power switch SW is turned on, a power supply 101 starts supplying necessary power to the overall head mounted display apparatus. A television signal (NTSC signal) from a TV tuner, video reproducing apparatus, or the like as an input signal source or an analog RGB signal from a personal computer, compact information terminal, or the like as an input signal source is input to a relay box 102. These operations are the same as those in the fourth embodiment. The NTSC signal is sent to an input signal switching means 169. The analog RGB signal is converted into an NTSC signal by a video signal conversion circuit 171 and sent to the input signal switching means 169. A connector used for the input signal source and disposed in the relay box 102 has a sensor for identifying an input signal as an NTSC or RGB signal. A control unit 166 switches the input signal switching means 169 to the NTSC signal side or the RGB signal side in accordance with the signal sent from the sensor. The input signal selected by the input signal switching means 169 is sent to a decoder processing unit 165. The control unit 166 transmits brightness or color information to the decoder processing unit 165 in accordance with the adjustment value set by the observer using an adjustment value input means 170. In this case, the brightness or color information is D/A-converted by a D/A conversion circuit 168 and sent to the decoder processing unit 165. The control unit 166 and the decoder processing unit 165 can be mounted on the same board, and hence electronic adjustment by the control unit 166 can be facilitated. The decoder processing unit 165 converts the NTSC signal into an RGB signal in accordance with the brightness or color information received from the D/A conversion circuit 168, and sends the RGB signal to a signal processing unit 164. A character generator 167 sends image data for a window to give the observer a caution/warning or to adjust brightness, color, and the like to the signal processing unit 164 in accordance with the instruction sent from the control unit 166. The signal processing unit 164 mixes the input video signal and the image data from the character generator 167. The resultant RGB signal is output from the relay box and sent to a display drive circuit 103, disposed in the main mount portion, through a cable or the like.

As described above, according to the circuit configuration of the head mounted display apparatus, the character generator for displaying a warning window for the observer or an adjustment window for brightness, color, and the like is disposed behind the decoder processing unit, and an RGB output from the character generator is used. Therefore, the limitations imposed on color are fewer than those in a case wherein an NTSC output is used. This can realize display of a warning window and adjustment window that are more easy for the observer to see and understand.

In addition, since an RGB output is used instead of an NTSC output from the character generator, a general-purpose character generator can be selected from a wider range of choices. This can easily and economically realize display of warning and adjustment windows that are easy to see and understand.

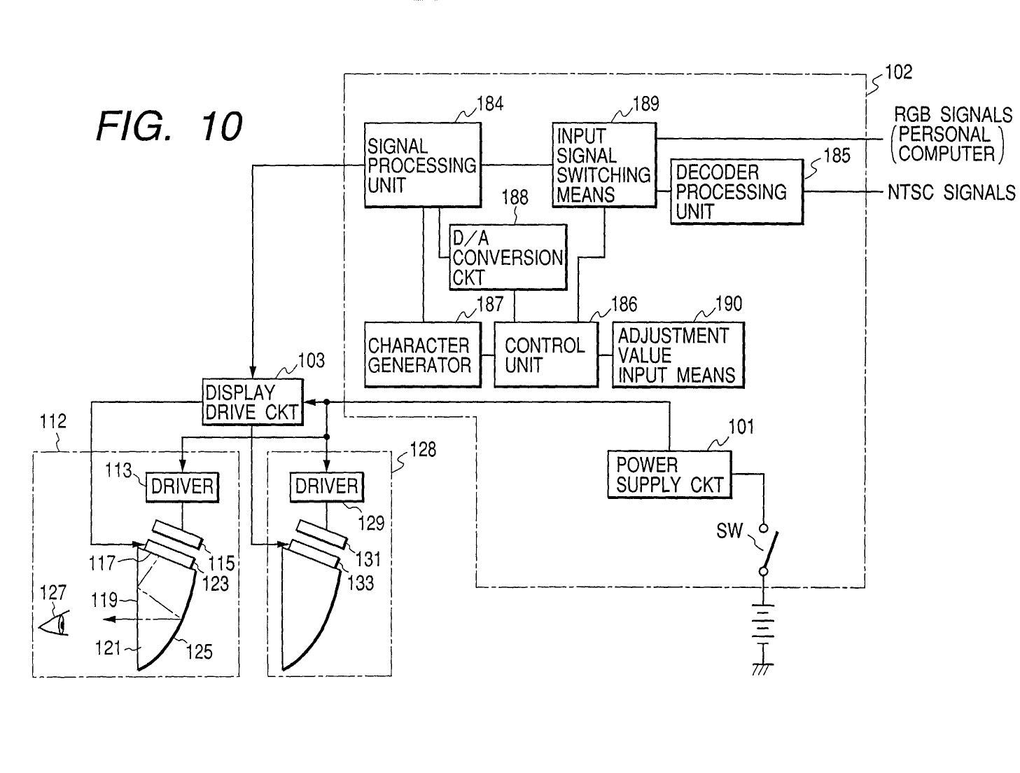

FIG. 10 is a block diagram showing the arrangement of the sixth embodiment of the present invention. The same reference numerals in this embodiment denote the same parts as in the previous embodiment.

A television signal (NTSC signal) from a TV tuner, video reproducing apparatus, or the like as an input signal source or an analog RGB signal from a personal computer, compact information terminal, or the like as an input signal source is input to a relay box 102. The analog RGB signal is sent to an input signal switching means 189. The NTSC signal is converted into an RGB signal by a decoder processing unit 185. The RGB signal is then sent to the input signal switching means 189. A connector used for the input signal source and disposed in the relay box 102 has a sensor for identifying an input signal as an NTSC or RGB signal. A control unit 186 switches the input signal switching means 189 to the NTSC signal side or the RGB signal side in accordance with the signal sent from the sensor. The input signal selected by the input signal switching means 189 is sent to a signal processing unit 184. A character generator 187 sends image data for a window to give the observer a caution/warning or to adjust brightness, color, and the like to the signal processing unit 184 in accordance with the instruction sent from the control unit 186. The signal processing unit 184 mixes the input video signal and the image data from the character generator 187. The control unit 186 transmits brightness or color information to the signal processing unit 184 in accordance with the adjustment value set by the observer using an adjustment value input means 190. In this case, the luminance or color information is D/A-converted by a D/A conversion circuit 188 and sent to the signal processing unit 184. The control unit 186 and the signal processing unit 184 can be mounted on the same board, and hence electronic adjustment by the control unit 186 can be facilitated. The signal value of the RGB signal is converted in accordance with the brightness or color information received from the D/A conversion circuit 188. The resultant signal is sent from the relay box to a display drive circuit 103, disposed in the main mount portion, through a cable or the like.

Referring to FIG. 10, the RGB signal from the signal processing unit 184 is directly sent to the main mount portion through the cable. However, to take measures against noise, the amplitude of the RGB signal may be amplified first by an amplifier, and then the amplified signal may be sent to the main body of the video display.

As has been described above, this apparatus can display not only a television signal (NTSC signal) from a TV tuner, video reproducing apparatus, or the like but also an analog RGB signal from a personal computer, compact information terminal, or the like. In addition, since an input RGB signal need not be converted into an NTSC signal by the video signal conversion means, the circuit size can be reduced, and a compact, lightweight apparatus can be realized. In addition, the apparatus can be realized at a low cost. Furthermore, since the signal processing means and the microcomputer are mounted on the same board, electronic adjustment of brightness, color, and volume can be easily performed under the control of the microcomputer. This can simplify the adjustment mechanism and attain a reduction in the number of parts such as a volume. Furthermore, the relay box may include an amplifier to reduce the influences of noise on an RGB signal.

What is claimed is:

1. A head mounted display apparatus comprising:
a main body portion to be mounted on a head of an observer, said main body portion including a video display unit, a video display drive circuit for displaying video on said video display unit, and an optical system for guiding the video displayed on said video display unit to a pupil of the observer, and said main body portion obtaining power from a power supply unit through a cable; and
a decoder processing unit for converting an external input video signal into an RGB signal, the signal from said decoder processing unit being transmitted to said video display drive circuit, and said decoder processing unit being disposed in a relay unit between said power supply unit and said main body portion.

2. An apparatus according to claim 1, wherein said decoder processing unit is disposed in a housing having a video signal input terminal.

3. An apparatus according to claim 1, wherein said relay unit further comprises a character generating unit for generating a character to be displayed on said display unit.

4. An apparatus according to claim 3, wherein a character signal from said character generating unit is mixed with a signal before the signal is decoded by said decoder processing unit.

5. An apparatus according to claim 3, wherein a character signal from said character generating unit is mixed with a signal after the signal is decoded by said decoder processing unit.

6. An apparatus according to claim 3, wherein said relay unit further comprises control means for controlling video.

7. An apparatus according to claim 6, wherein said decoder processing unit, said character generating unit, and said control means are mounted on the same board.

8. An apparatus according to claim 6, wherein electronic adjustment of a video parameter is executed by said control means.

9. An apparatus according to claim 1, wherein said relay unit further comprises a video signal conversion circuit for converting an external input RGB signal into an NTSC signal.

10. An apparatus according to claim 9, wherein said relay unit further comprises means for switching the input RGB signal and the input video signal as an input signal.

11. An apparatus according to claim 9, wherein said relay unit further comprises means for mixing a character signal with an output from said video signal conversion circuit or the input video signal, and the signal mixed with the character signal is input to said decoder processing unit.

12. An apparatus according to claim 9, wherein an output from said video signal conversion circuit or the input video signal is input to said decoder processing unit, and said relay unit further comprises means for mixing a character signal with a signal processed by said decoder processing unit.

13. An apparatus according to claim 1, wherein said relay unit comprises an input unit an external input RGB signal and means for mixing a character signal with an output from said decoder processing unit or the external input RGB signal.

14. A head mounted display apparatus comprising:
a main body portion to be mounted on a head of an observer, said main body portion including a video display unit, a video display drive circuit for displaying video on said video display unit, and an optical system for guiding the video displayed on said video display unit to a pupil of the observer; and
an input unit disposed separately from said main body portion and having a video signal input terminal, said input unit transmitting an external input video signal as an RGB signal to said video display drive circuit.

15. An apparatus according to claim 14, wherein said input unit further comprises an amplifier for amplifying the RGB signal.

16. An apparatus according to claim 14, wherein said input unit further comprises a cha r generating unit for generating a character to be displayed on said display unit.

17. An apparatus according to claim 16, said input unit further comprises decoder processing means for converting an input video signal into an RGB signal.

18. An apparatus according to claim 17, wherein a character signal from said character generating unit is mixed with a signal before the signal is decoded by said decoder processing unit.

19. An apparatus according to claim 17, wherein a character signal from said character generating unit is mixed with a signal after the signal is decoded by said decoder processing unit.

20. An apparatus according to claim 17, wherein said input unit further comprises control means for controlling video.

21. An apparatus according to claim 20, wherein said decoder processing unit, said character generating unit, and said control means are mounted on the same board.

22. An apparatus according to claim 20, wherein electronic adjustment of a video parameter is executed by said control means.

23. An apparatus according to claim 14, wherein said input unit further comprises a video signal conversion circuit for converting an external input RGB signal into an NTSC signal.

24. An apparatus according to claim 23, wherein said input unit further comprises means for switching the input RGB signal and the input video signal as an input signal.

25. An apparatus according to claim 23, wherein said input unit further comprises means for mixing a character signal with an output from said video signal conversion circuit or the input video signal, and a decoder processing unit for converting the signal mixed with the character signal into an RGB signal.

26. An apparatus according to claim 23, wherein said input unit further comprises a decoder processing unit for converting an output from said video signal conversion circuit or the input video signal into an RGB signal, and means for mixing a character signal with the signal processed by said decoder processing unit.

27. An apparatus according to claim 14, wherein said input unit further comprises a decoder processing unit for converting the input video signal into an RGB signal, an input terminal for an external input RGB signal, and means for mixing a character signal with an output from said decoder processing unit or the external input RGB signal.
